(19) United States
(12) Patent Application Publication
(10) Pub. No.: US 2004/0125586 A1
(43) Pub. Date: Jul. 1, 2004

(54) Back light unit

(76) Inventor: Yi-Chun Ho, Taipei Hsien (TW)

Correspondence Address: Jason Z. LIN, Supreme Patent Services, Post Office Box 2339, Saratoga, CA, 95070-0339, US

(21) Appl. No.: 10/330,592

(22) Filed: Dec. 27, 2002

(51) Int. Cl. G01D 11/28

(52) U.S. Cl. 362/27; 362/31; 362/555

(57) ABSTRACT

A back light unit includes a light guiding plate for guiding and redirecting light and two light sources located on one end of the light guiding plate and arranged in a line with the light guiding plate. A reflector covers the light sources entirely and is fixed to the end the light guiding plate. The reflector forms curved reflecting surfaces respectively corresponding to the light sources in position and contour for reflecting and redirecting light emitted from the sources toward the light guiding plate.

### FIELD OF THE INVENTION

The present invention relates to a back light unit for liquid crystal display device, and more particularly to a back light unit having a reflector with a plurality of light sources and a plurality reflecting surfaces corresponding to the light sources.

### BACKGROUND OF THE INVENTION

The trend of miniaturization in electronic industry requires electronic parts to be light weight and small size, as well as low power consumption. Compared to other display devices, such as cathode ray tube (CRT), liquid crystal displays (LCDs) are a small size and low power consumption display device. In addiction to liquid crystal panel, the LCD requires a light source because the liquid crystal panel is not a self-luminous device.

Currently, lamps, such as cold cathode fluorescent lamps (CCFLs) and hot cathode fluorescent amps (HCFLs),are commonly used as a light source for LCD. The light source for an LCD is made as a back light unit for projecting light toward the liquid crystal panel. The back light unit is divided into a “direct part lighting” type and an “edge lighting type”, according to the location of the lamp source. In the direct part lighting type, a lamp light is uniformly distributed through the liquid crystal panel by a diffusing sheet, while the edge lighting type back light unit comprises a light guiding plate for projecting the light through a surface and forming planar light source.

FIG. 1 of the attached drawingsillustrates a conventional edge-light type back light unit. A lamp 10, serving as a light source, is surrounded by a lamp reflector 20. A light guiding plate 3 is disposed on one side of the lamp 10 for scattering and distributing the light from the lamp 10. Optical sheets consisting of a diffusing sheet 50 and a lower prism sheet 60 and an upper prism sheet 70 are disposed above the light guiding plate 20. A reflecting sheet 40 is disposed below the light guiding plate 30.

The diffusing sheet 50 improves the uniformity of distribution of incident light on a liquid crystal panel (not shown). The reflecting sheet 40 eliminate light leakage through the lower side of the light guiding plate 30 and reflects the light perpendicularly to the light guiding plate 30. The lower and upper prism sheets 60, 70 redirect the travel path of the light and are composed of a sequence of troughs in the shape of triangle or hemisphere. To protect the lower and upper prism sheets 60, 70, a protecting sheet 80 is disposed on the upper prism sheet 70. The liquid crystal panel is disposed on the protecting sheet 80.

The back light unit is fixed on a support frame 9 which s formed by injection molding.

The light emitted from the lamp 10 is reflected by the lamp reflector 20, and images on the display screen is displayed by the lights passing through the light guiding plate 30 and the diffusing sheet 50. Especially, the light emitted from the lamp 10 that travels in a direction away from the light guiding plate 30 is reflected toward the light guiding plate 30 by the reflecting sheet 40. The diffusing sheet 50 uniformly distributes and redirects the light toward the liquid crystal panel by guiding the light to travel at a selected angle through the lower and the upper prism sheets 60, 70.

To increase the luminance of the back light unit, there have been proposed to use lamps, designated with reference numeral 220 FIG. 2B, which is larger than traditional lamps, designated with reference numeral 210 in FIG. 2A. The large lamp 220 has a luminance of 3300 cd/m² while the traditional lamp 210 provides a measured luminance L=2600 cd/m². Alternatively, two or more lamps, reference numerals 230, 240, 250, 260 in FIGS. 2C and 2D, are employed to realize high luminance which achieves 4500 cd/m². However, the size and weight of the back light unit increase with the increasing luminance. In addition, the example shown in FIG. 2D has a drawback that the lamps themselves absorb the light energy, making the overall luminance as low as about 2700 cd/m².

In order to overcome the defects mentioned above and still can make the back light unit thin and light-weighted, there is a need to develop a back light module to solve the above problems.

### SUMMARY OF THE INVENTION

Therefore, a primary object of the present invention is to provide a back light unit which is small in size and light in weight.

It is another object of the present invention to provide a back light unit having a reflector forming a curved reflecting surface which eliminates light energy absorption between lamps, and properly reflect the light toward a light guiding plate of the back light unit to enhance luminance.

According the above mentioned objects, the present invention provides a back light unit which comprises a light guiding plate for guiding and redirecting light, a first light source and a second light source, disposed on one side of the light guiding plate and in a line with the light guiding plate. A reflector covers the light sources entirely and is fixed to the end of the light guiding plate. The reflector forms reflecting surfaces respectively corresponding to the light sources in position and contour for reflecting and redirecting light emitted from the sources toward the light guiding plate. Properly separating the two light sources and reflecting the light respectively toward the light guiding plate by the reflecting surfaces effectively eliminating energy absorption by the light source themselves. The overall luminance is thus enhanced. Due to the alignment arrangement of the light guiding plate and the light sources, thickness of the back light unit is reduced.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is an exploded view of a conventional back light unit;

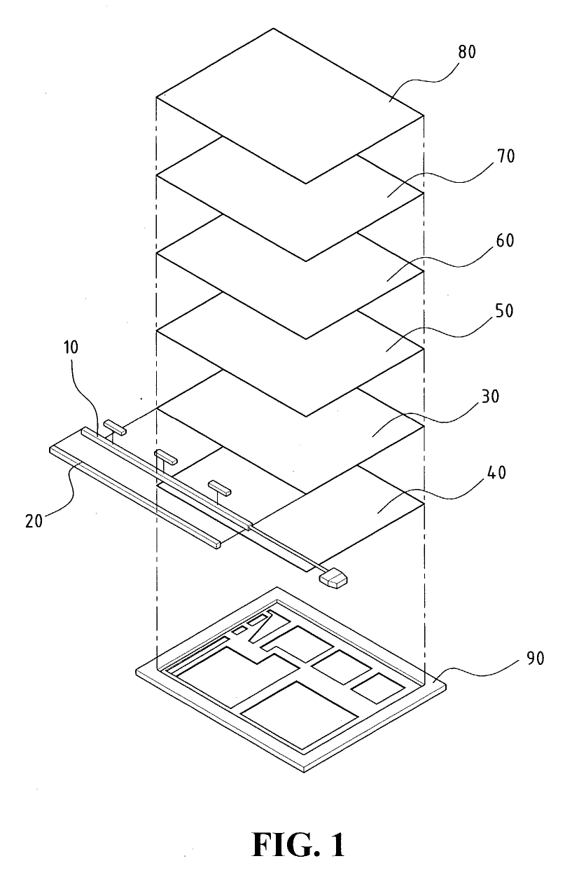

FIGS. 2A to 2D are cross-sectional views showing different arrangements of lamps for the conventional back light unit;

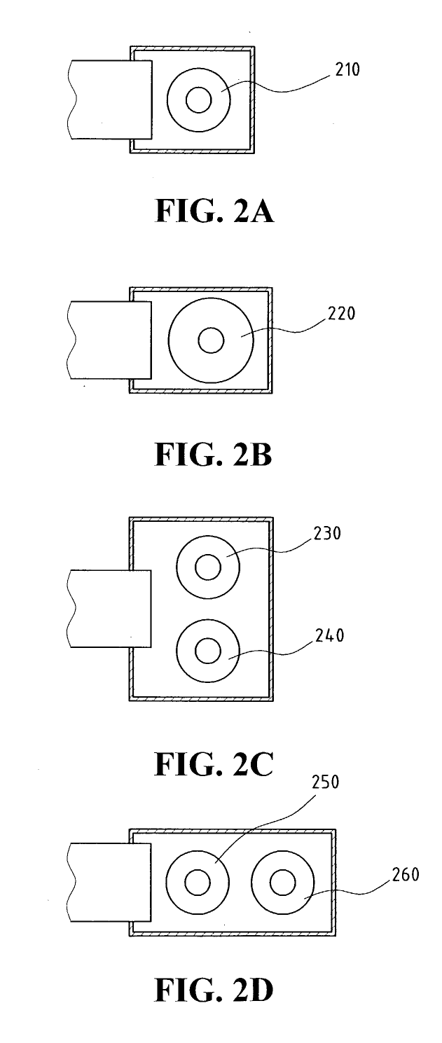

FIG. 3 is a side elevational view of a light source for a back light unit in accordance with the present invention; and

FIG. 4 is a perspective view of the light source of the back light unit in accordance with the present invention.

### DESCRIPTION OF THE INVENTION

An embodiment of the invention will now be described in greater detail. Nevertheless, it should be recognized that the present invention can be practiced in a wide range of other embodiments besides that explicitly described, and the scope of the present invention is expressly not limited except as specified in the accompanying claims.

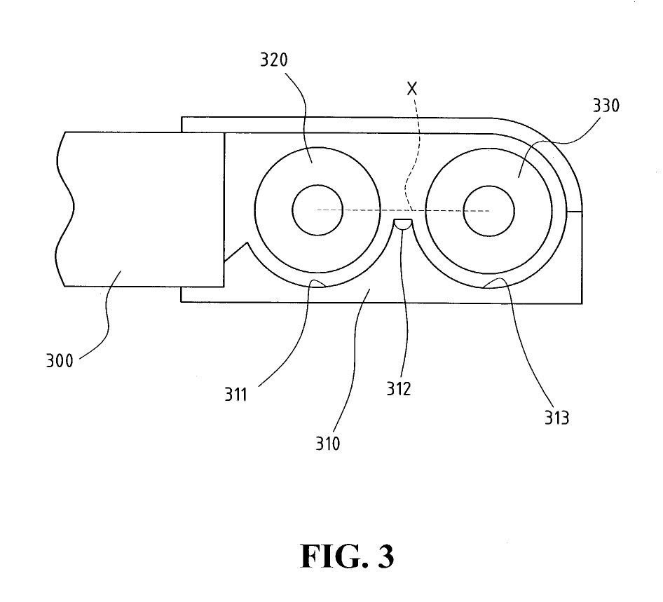

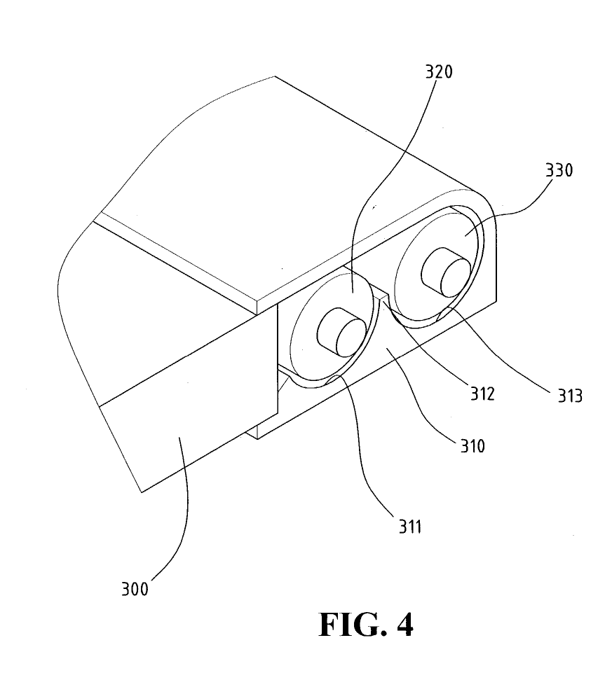

Referring to FIGS. 3 and 4, a back light unit of the present invention comprises a light guiding plate 300 for guiding and redirecting light, a first light source 320 and a second light source 330, which may be cold cathode fluorescent lamps (CCFLs), light emitting diodes and other proper light sources. The light sources 320, 330 are arranged in a line with the light guiding plate 300 on one side of the light guiding plate 300. A reflector 310, covering the first light source 320 and the second light source 330 entirely, is fixed to the corresponding side of the light guiding plate 300.

The reflector 310 comprises a first reflecting surface 311 and a second reflecting surface 313, respectively corresponding to the first light source 320 and the second light source 330. The first and second reflecting surfaces 311, 313 are curved surfaces formed on one side of the light sources 320, 330 for redirecting the light emitted from the light sources 320, 330 toward the light guiding plate 300. The reflector 310 forms a junction part between the first reflecting surface 311 and the second reflecting surface 313, constituted by a protuberance 312 from the wall of the reflector 310, which extends in between the first and second light sources 320, 330. To avoid blocking transmission of light from the second light source 330 toward the light guiding plate 300, the tip of the protuberance 312 is below a line connecting between centers of the light sources 320, 330.

Because of properly separating the two light source 320, 330 and reflecting the light respectively toward light guiding plate 300 by the curved reflecting surfaces 311, 313, absorption of energy of the light emitted from the light sources 320, 330 by other light sources 320, 330 is effectively reduced and the total luminance is enhanced. For example, the luminance measured in an example in accordance with the present invention is 4300 cd/m² which is obviously higher than the prior art. In addiction, since the light guiding plate 300, the first light source 320 and the second source 330 are arranged in a line, thickness of the back light unit is reduced.

What is claimed is:

1. A back light unit comprising:
a light guiding plate having an end;
a light source arranged in line with the light guiding plate; and
a reflector mounted to the end of the light guiding plate and covering the light source entirely, the reflector forming a curved reflecting surface corresponding to the light source for reflecting and rediercting the light emitted from the light source toward the end of the light guiding plate.

2. The back light unit according to claim 1, wherein the curved reflecting surface has a contour partly corresponding to the light source.

3. The back light unit according to claim 1, wherein the light source comprises a cold cathode fluorescent lamp.

4. The back light unit according to claim 1, wherein the light source comprises a light emitting diode.

5. The back light unit according to claim 1 comprising two light sources arranged in line with the end of the light guiding plate, the reflector covering the light sources entirely, and forming two reflecting surfaces corresponding to the light sources, respectively, for reflecting light emitted from the light sources toward said the end of the light guiding plate.

6. The back light unit according to claim 5, wherein the curved reflecting surfaces have contours partly corresponding to the light sources.

7. The back light unit according to claim 6, wherein the reflector forms a protuberance between the curved reflecting surfaces and extending in between the light sources,.

8. The back light unit according to claim 7, wherein the protuberance has a tip below a connecting line between centers of the light sources.

9. The back light unit according to claim 6, wherein the light sources comprise cold cathode fluorescent lamps.

10. The back light unit according to claim 6, wherein the light sources comprise light emitting diodes.
